(19) United States
(12) Patent Application Publication
(10) Pub. No.: US 2011/0147554 A1
(43) Pub. Date: Jun. 23, 2011

(54) HOLDING DEVICE OF FITMENTS

(76) Inventors: KUO-CHANG LIAO, TAICHUNG (TW); CHUN-WEI LIAO, TAICHUNG (TW)

(21) Appl. No.: 12/643,050

(22) Filed: Dec. 21, 2009

(51) Int. Cl. F16M 13/00

(52) U.S. Cl. 248/226.11

(57) ABSTRACT

A holding device of fitments is disposed to a support on one side of the fitment and comprises a holding plate including a coupling portion extending from one side of a bottom thereof; a connecting set including a disc extending upward from one end thereof, a fitting segment extending downward from another end thereof, and an insertion on a distal section of the fitting segment; a clamping set comprised of first and second engaging portions, an acting surface of each of the first and second engaging portions including an uneven contact section to engage with different supports, and including a receiving member with a through aperture to receive the fitting segment and the insertion.

### BACKGROUND OF THE INVENTION

1. Field of the Invention

The present invention relates to a holding device of fitments that the uneven contact sections of the first and second engaging portions are allowed to engage different supports securely.

2. Description of the Prior Art

Conventional holding devices are used to cooperate with different fitments; however, the holding device can not engage different supports securely.

The present invention has arisen to mitigate and/or obviate the afore-described disadvantages.

### SUMMARY OF THE INVENTION

The primary object of the present invention is to provide a holding device of fitments that the uneven contact sections of the first and second engaging portions are allowed to engage different supports securely.

A further object of the present invention is to provide a holding device of fitments that the first and second teeth are adjusted based on a tilted angle of the support to keep the holding plate horizontal.

Another object of the present invention is to provide a holding device of fitments that the uneven contact sections of the first and second engaging portions are formed in a concave and convex teeth manner to engage the support securely.

A holding device of fitments in accordance with a preferred embodiment of the present invention is disposed to a support on one side of the fitment and comprises a holding plate including a coupling portion extending from one side of a bottom thereof; a connecting set including a disc extending upward from one end thereof, a fitting segment extending downward from another end thereof, and an insertion on a distal section of the fitting segment; a clamping set comprised of first and second engaging portions, an acting surface of each of the first and second engaging portions including an uneven contact section to engage with different supports, and including a receiving member with a through aperture to receive the fitting segment and the insertion

### BRIEF DESCRIPTION OF THE DRAWINGS

FIG. 1 is a perspective view showing the exploded components of a holding device of fitments according to a preferred embodiment of the present invention;

FIG. 2 is a cross sectional view showing the assembly of the holding device of the fitments according to the preferred embodiment of the present invention;

FIG. 3 is another cross sectional view showing the assembly of the holding device of the fitments according to the preferred embodiment of the present invention;

FIG. 4 is a perspective view showing the operation of the holding device of the fitments according to the preferred embodiment of the present invention;

FIG. 4-1 is a cross sectional view showing the contact section being used to engage a circular support according to the preferred embodiment of the present invention;

FIG. 4-2 is a cross sectional view showing the contact section being used to engage a square support according to the preferred embodiment of the present invention;

FIG. 4-3 is a cross sectional view showing the contact section being used to engage a rectangular support according to the preferred embodiment of the present invention;

FIG. 4-4 is a cross sectional view showing the contact section being used to engage an oval support according to the preferred embodiment of the present invention;

FIG. 5 is a cross sectional view showing the operation of the holding device of the fitments according to the preferred embodiment of the present invention;

FIG. 6 is a plan view showing the operation of the holding device of the fitments according to the preferred embodiment of the present invention;

FIG. 7 is a perspective view showing the holding device of the present invention being assembled to one side of a chair;

FIG. 8 is a perspective view showing two holding devices of the present invention being assembled to two sides of the chair individually.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

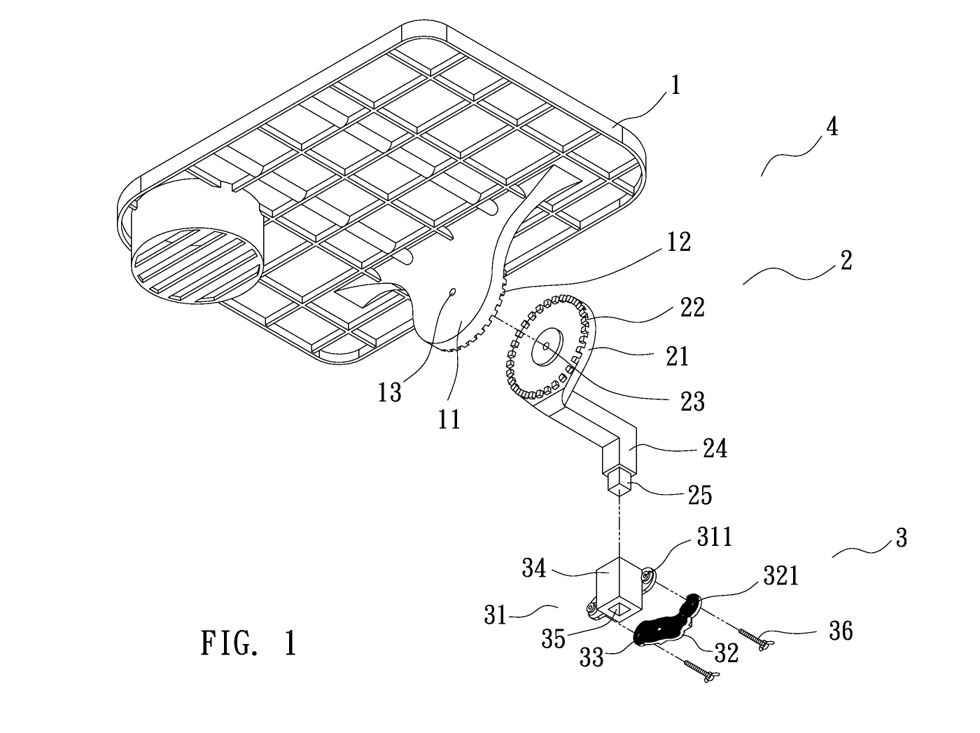

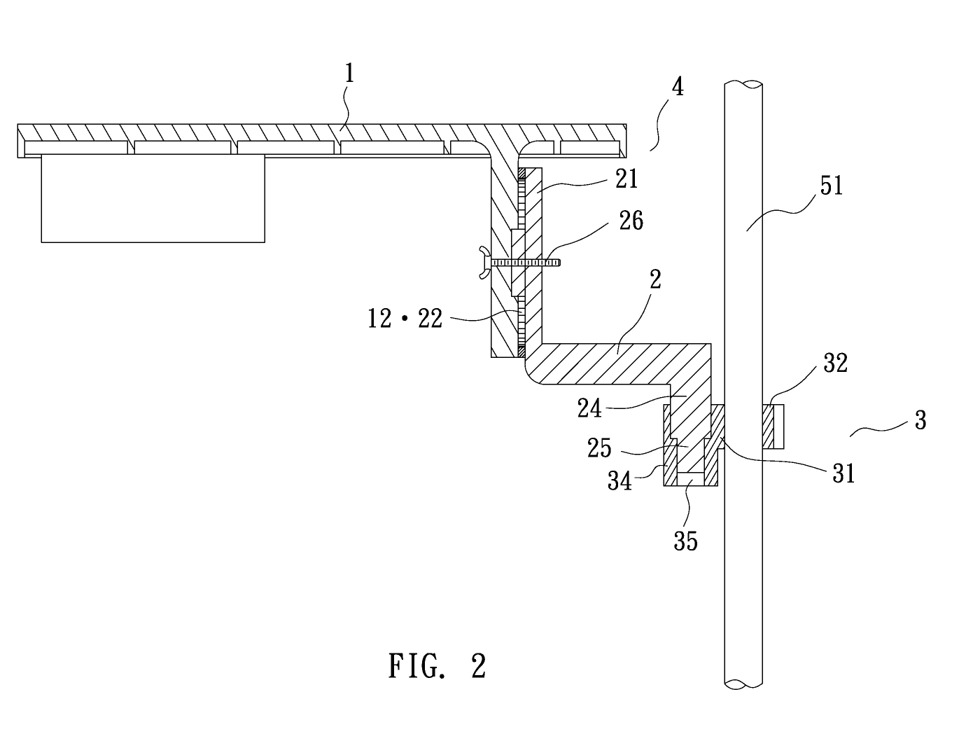

Referring to FIGS. 1 and 2, a holding device of fitments in accordance with a preferred embodiment of the present invention comprises a holding plate 1, a connecting set 2, and a clamping set 3, wherein

the holding plate 1 including a coupling portion 11 extending from one side of a bottom thereof and having a plurality of first teeth 12 formed around a peripheral side of the coupling portion 11, and having a first hole 13 formed at a central portion around the first teeth 12;

the connecting set 2 including a disc 21 extending upward from one end thereof and having a number of second teeth 22 arranged around an outer rim of the disc 21, including a first screw bore 23 at a central portion of the disc 21, including a fitting segment 24 extending downward from another end thereof, and an insertion 25 on a distal section of the fitting segment 24;

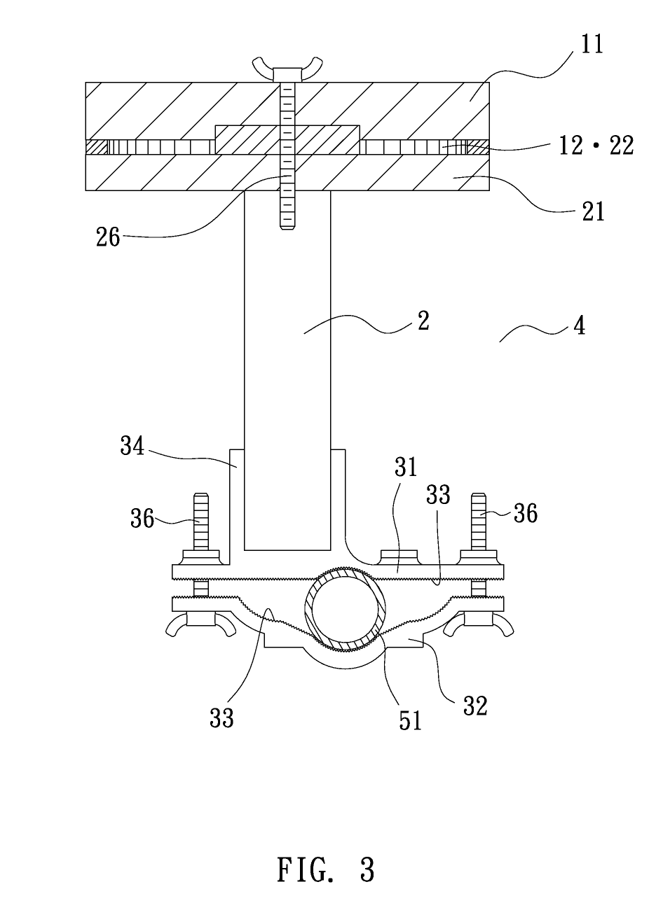

the clamping set 3 comprised of first and second engaging portions 31, 32, an acting surface of each of the first and second engaging portions 31, 32 including an uneven contact section 33 (as shown in FIG. 3, the uneven contact section 33 is embodied in a concave and convex teeth manner) to engage with a support 51, and including a receiving member 34 with a through aperture 35 to receive the insertion 25, and the first and second engaging portions 31, 32 including two second screw bores 311 and two second holes 321 on two sides thereof respectively to lock the first and second engaging portions 31, 32 together by using second screwing elements 36.

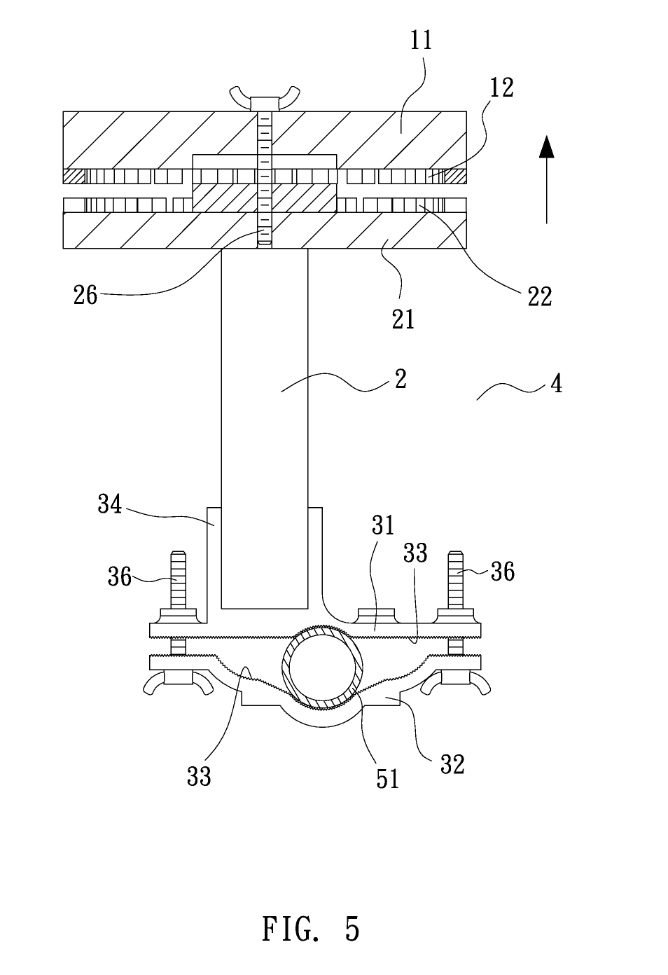

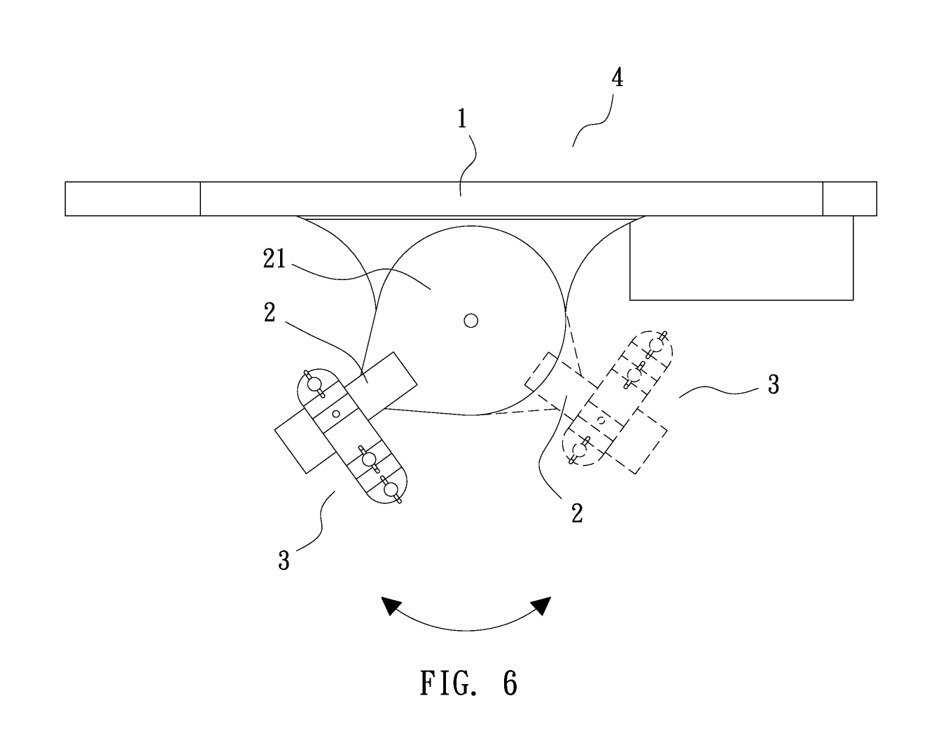

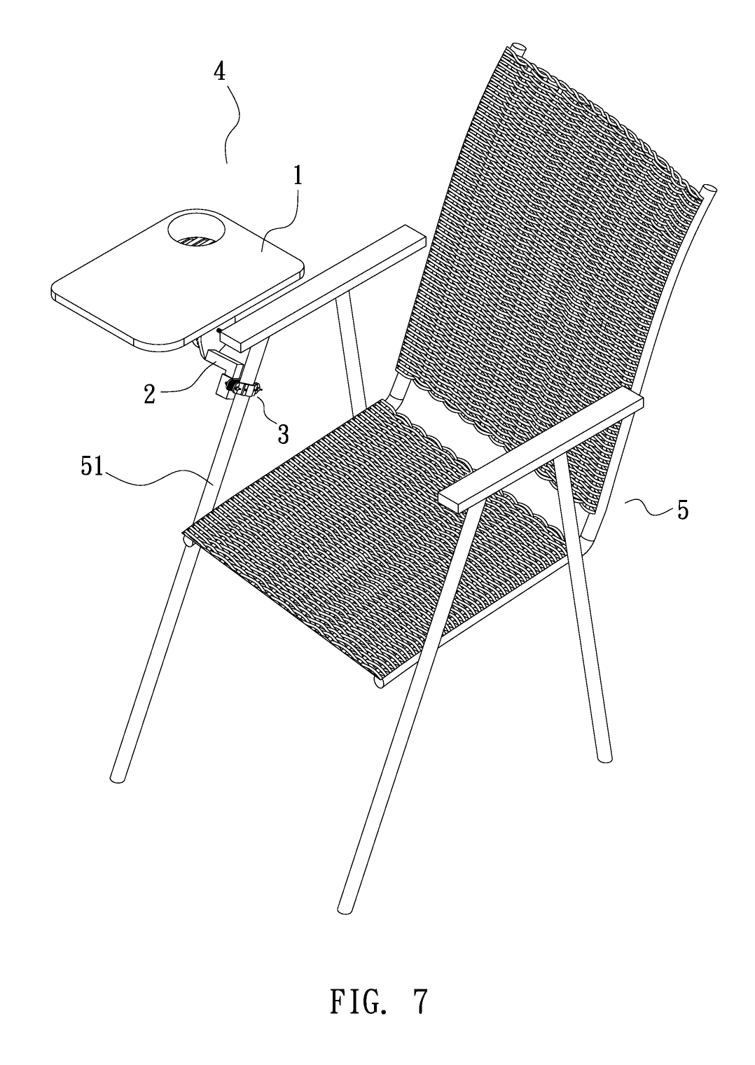

In assembly of the holding plate 1, the connecting set 2, and the clamping set 3 by ways of a support 51 (as illustrated in FIGS. 2-4), the first and second engaging portions 31, 32 are engaged to the support 51, and then the second screwing elements 36 are inserted through the second screw bores 311 and the second holes 321 of the first and second engaging portions 31, 32 so that the support 51 is fixed between the clamping set 3. Thereafter, the first teeth 12 of the coupling portion 11 of the holding plate 1 are engaged with the second teeth 22 of the disc 21 of the connecting set 2, and a first screwing element 26 is inserted through the coupling portion 11, the first hole 13 of the disc 21, and the first screw bore 23 of the connecting set 2 to assemble the holding plate 1 and the connecting set 2 together. Besides, the fitting segment 24 and the insertion 25 of the connecting set 2 are inserted to the through aperture 35 of the receiving portion 34 of the clamping set 3 (as illustrated in FIG. 2), and then a holding device 4 of the fitment is adjusted laterally (as shown in FIGS. 5 and 6) so that the first screwing element 26 between the coupling portion 11 of the holding plate 1 and the disc 21 of the connecting set 2 is unfastened backward (as shown in FIG. 5), such that the first and the second teeth 12, 22 disengage from each other, hence the holding plate 1 is adjusted horizontally relative to a fitment 5 (as shown in FIG. 7).

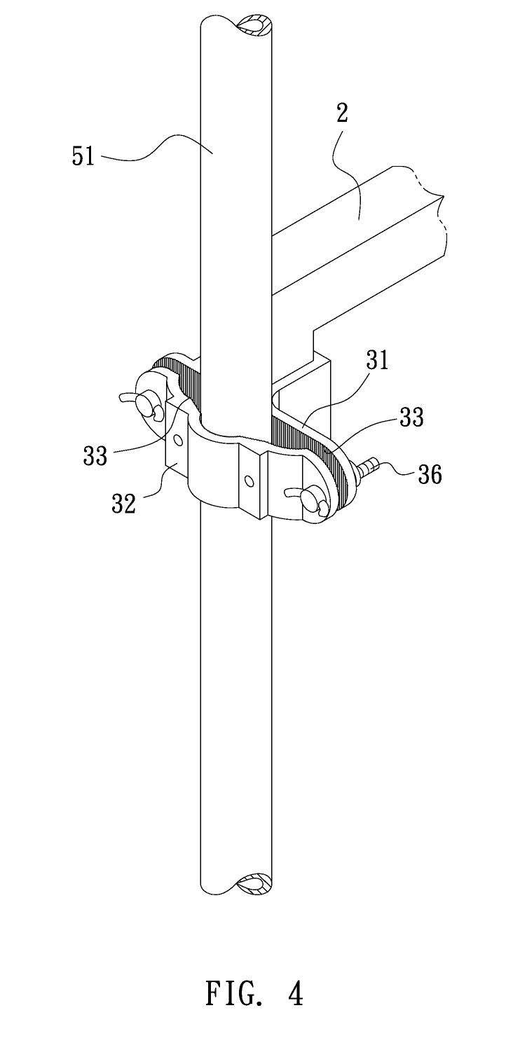

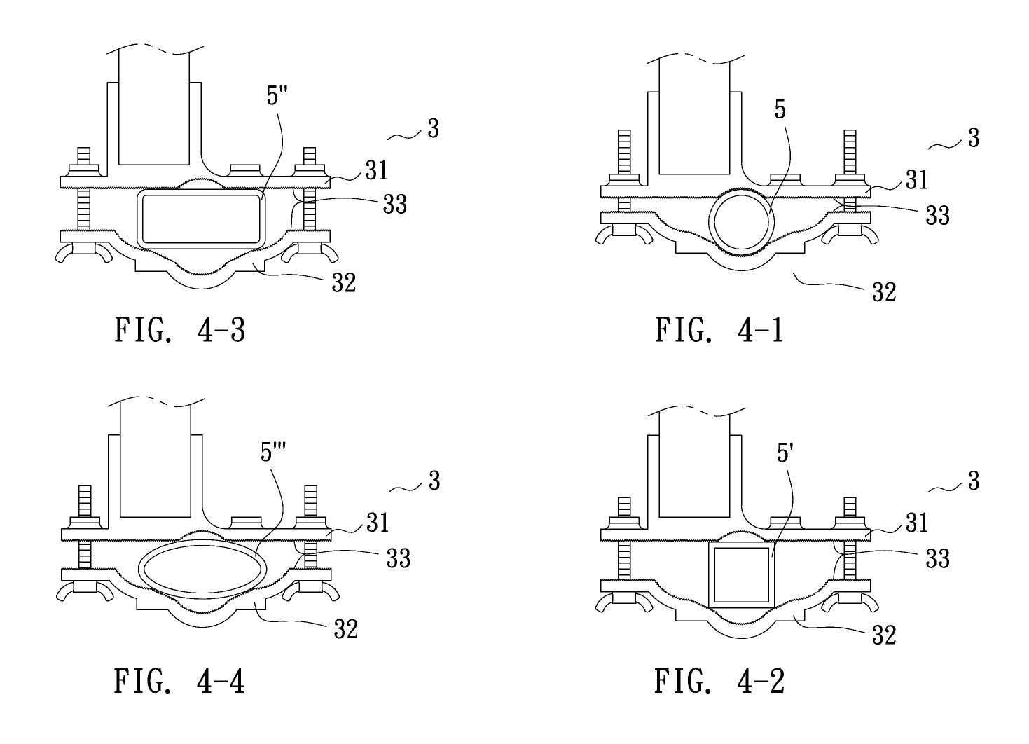

The uneven contact section 33 is used to engage various supports on a single direction. Referring to FIG. 4-1, the contact section 33 is used to engage a circular support 51, and the contact section 33 is applied to engage a square support 51′ as shown in FIG. 4-2. Referring to FIG. 4-3, the contact section 33 is used to engage a rectangular support 51″, and the contact section 33 is applied to engage an oval support 51′″ as shown in FIG. 4-4, such that the contact section 33 engages with different supports securely. Furthermore, the clamping set 3 is used to clamp the support 51, 51′, 51″, and 51′″, wherein the uneven contact sections 33 of the first and second engaging portions 31, 32 are formed in a concave and convex teeth shape to engage the different supports securely.

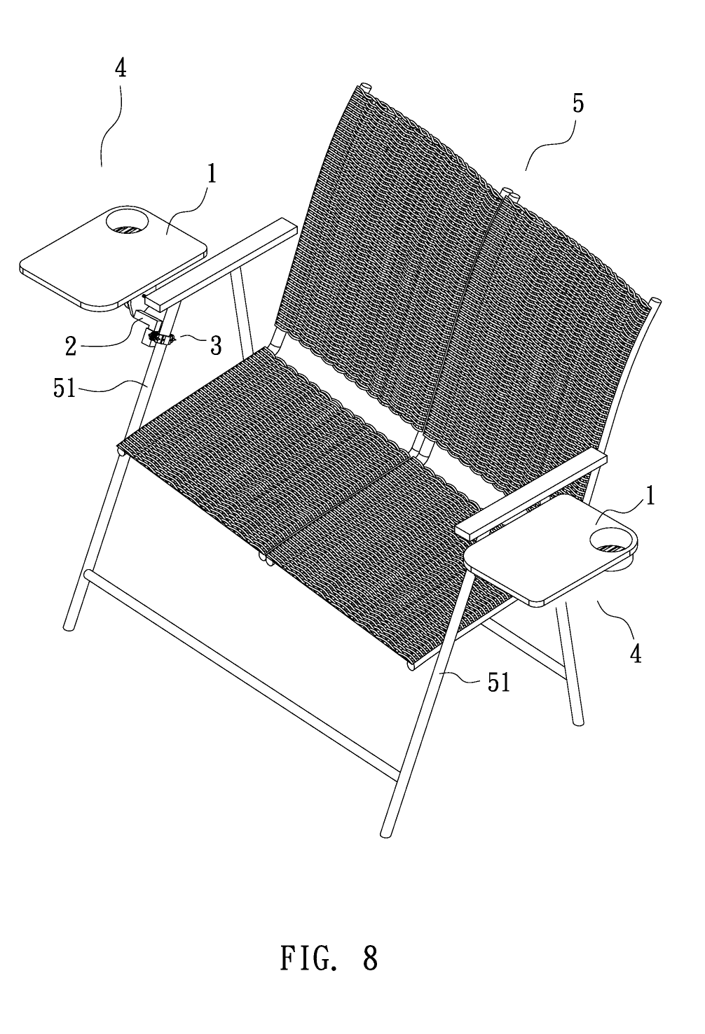

Furthermore, the holding device 4 allows to be fixed on the supports 51 on two sides of the fitment 5 as shown in FIG. 8.

While we have shown and described various embodiments in accordance with the present invention, it is clear to those skilled in the art that further embodiments may be made without departing from the scope of the present invention.

What is claimed is:

1. A holding device of fitments being disposed to a support on one side of the fitment and comprising:
a holding plate including a coupling portion extending from one side of a bottom thereof;
a connecting set including a disc extending upward from one end thereof, a fitting segment extending downward from another end thereof, and an insertion on a distal section of the fitting segment;
a clamping set comprised of first and second engaging portions, an acting surface of each of the first and second engaging portions including an uneven contact section to engage with different supports, and including a receiving member with a through aperture to receive the fitting segment and the insertion.

2. The holding device of the fitments as claimed in claim 1, wherein the coupling portion includes a plurality of first teeth formed around a peripheral side thereof, and the disc includes a number of second teeth arranged around an outer rim thereof so that the first and second teeth are adjusted based on a tilted angle of the support to keep the holding plate horizontal.

3. The holding device of the fitments as claimed in claim 1, wherein the uneven contact sections of the first and second engaging portions are formed in a concave and convex teeth manner to engage the support securely.
